(19) United States
(12) Patent Application Publication
(10) Pub. No.: US 2026/0363239 A1
(43) Pub. Date: Nov. 19, 2026

(54) COMPOSITIONS TO CONTROL LEVEL OF UNDESIRABLE MATERIALS

(71) Applicant: Solugen, Inc., Houston, TX (US)

(72) Inventors: Jun Su An, Houston, TX (US); Gaurab Chakrabarti, Houston, TX (US); Sean Hunt, Houston, TX (US); David Weiner, Houston, TX (US); LoongYi Tan, Houston, TX (US)

(73) Assignee: Solugen, Inc., Houston, TX (US)

(21) Appl. No.: 19/121,072

(22) PCT Filed: Oct. 16, 2023
(86) PCT No.: PCT/US2023/076992

§ 371 Date: Apr. 14, 2025

Related U.S. Application Data
(60) Provisional application No. 63/379,468, filed on Oct. 14, 2022.

(51) Int. Cl. A01N 35/02; A01N 25/02; A01P 1/00

(52) U.S. Cl. CPC A01N 35/02; A01N 25/02; A01P 1/00

(57) ABSTRACT

A mitigating composition comprising (i) one or more sugar oxidation products; (ii) a solvent; and (iii) one or more compounds selected from the group consisting essentially of a surfactant, a chelating agent, a biocide, and combinations thereof. A method comprising introducing to a system a mitigating composition in an amount effective to control the level of a pathogenic organism associated with the system wherein the mitigating composition comprises (i) one or more sugar oxidation products; (ii) a solvent; and (iii) one or more compounds selected from the group consisting essentially of a surfactant, a chelating agent, a biocide, and combinations thereof. A blend comprising (i) a mitigating composition and (ii) a material selected from the group consisting essentially of a feed product, a food product, a pesticide, a medicament, a pharmaceutical product, a cosmetic product and combinations thereof.

### CROSS-REFERENCE TO RELATED APPLICATIONS

This application is a 35 U.S.C. § 371 national stage application of PCT/US2023/076992 filed Oct. 16, 2023, and entitled “Compositions to Control Level of Undesirable Materials,” which claims priority to and the benefit of U.S. Provisional Application Ser. No. 63/379,468 filed Oct. 14, 2022, and entitled “Biocide Compositions and Methods of Making and Using Same,” each of which is hereby incorporated herein by reference in its entirety for all purposes.

### STATEMENT REGARDING FEDERALLY SPONSORED RESEARCH OR DEVELOPMENT

Not applicable.

### FIELD

The present disclosure relates generally to compositions that function to control the level of undesirable materials in an environment. More particularly, the present disclosure relates to materials derived from compounds sourced from renewable resources that mitigate the levels of undesirable biological and inorganic materials.

### BACKGROUND

Various compositions are used daily in controlling the type and level of undesirable materials (e.g., inorganic compounds, organic compounds, microorganisms) present in industrial processes. For example, one type of composition is a biocide. Biocides have been extensively used in the control of bacteria for decades and are commonly incorporated into a variety of products including disinfectant formulations, cosmetics, preservatives, pesticides and antiseptics. Biocides refer to compositions that are intended to destroy, deter, render harmless, prevent the action of, or otherwise exert a controlling effect on one or more pathogens by chemical or biological means. However, the term biocide is commonly used as synonym of antimicrobial agent or disinfectant/sanitizers. In such cases the term biocide can be differentiated and defined independently as follows (a) biocides which refer to active substances that above certain concentrations and defined conditions will kill cells within specified times; and (ii) antimicrobial agents which refer to active substances that have adverse effects on the growth or survival of microorganisms and; (iii) disinfectants/sanitizers which refer to formulations containing active substances that are safe for the application to inanimate surfaces and which kill specified groups of disease-producing microorganisms within specified times.

Biocides are commonly used to ensure that countless manufacturing and industrial processes are not compromised by microorganism growth. While biocide formulations may vary, biocides are commonly mixtures of disinfectants and topical agents such as antiseptics and preservatives including, but not limited to, quaternary ammonium compounds (QACs), biguanides, chlorine-releasing agents and peroxygens. The production of these compounds typically employ unfavorable conditions such as harsh chemicals and are characterized by an undesirable carbon footprint.

In addition to the need to control the presence of pathogens in a variety of systems there also exists a need to reduce the level of inorganic contaminants such as hydrogen sulfide in a system. An ongoing need exists for novel compositions able to function effectively as agents for the mitigation of undesirable materials from a system, termed MUM, that may advantageously be derived from a renewable resource under environmentally friendly conditions.

### BRIEF DESCRIPTION OF DRAWINGS

For a detailed description of the aspects of the disclosed processes and systems, reference will now be made to the accompanying drawings in which:

FIG. 1A depicts the structure of glycolaldehyde.

FIG. 1B depicts the structure of glyoxal.

### SUMMARY

Disclosed herein is a mitigating composition comprising (i) one or more sugar oxidation products; (ii) a solvent; and (iii) one or more compounds selected from the group consisting essentially of a surfactant, a chelating agent, a biocide, and combinations thereof.

Also disclosed herein is a method comprising introducing to a system a mitigating composition in an amount effective to control the level of a pathogenic organism associated with the system wherein the mitigating composition comprises (i) one or more sugar oxidation products; (ii) a solvent; and (iii) one or more compounds selected from the group consisting essentially of a surfactant, a chelating agent, a biocide, and combinations thereof.

Also disclosed herein is a blend comprising (i) a mitigating composition and (ii) a material selected from the group consisting essentially of a feed product, a food product, a pesticide, a medicament, a pharmaceutical product, a cosmetic product and combinations thereof.

### DETAILED DESCRIPTION

Disclosed herein are novel formulations that function to reduce the amount of a one or more undesirable materials in a system (MUMs). The undesirable material may be a pathogen. Herein pathogens refer to bacteria, viruses or cysts, capable of causing diseases in a host. In another aspect, the undesirable material may be one or more inorganic compounds such as a sulfide-containing compound.

The presently disclosed materials may function as a MUM alone or in conjunction with additional components to provide one or more modalities for controlling the level of undesirables in a particular system. It is contemplated that the MUMs provided herein may exhibit more than one modality for control of the level of undesirable materials in a system. In one or more aspects, depending on the context in which the MUMs is deployed, the MUM may function as a disinfectant, a preservative, a pest control agent, an antifoulant or combinations thereof. Disclosed herein are MUMs comprising one or more sugar oxidation products, a solvent and at least one compound selected from the group consisting of organic acids, chelating agents, surfactants, and combinations thereof.

In one or more aspects, the MUM comprises one or more sugar oxidation products (SOPs). SOPs suitable for use in the present disclosure may comprise aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycolaldehyde, glyoxal, salts thereof, lactones thereof or combinations thereof.

In an aspect, one or more SOPs suitable for use in the present disclosure comprises less than about 5 wt. % maltose, maltotriose, fructose, higher molecular weight polysaccharides, oxidation products thereof or a combination thereof based on the total weight of the sugar oxidation product. In one or more aspects, the one or more SOPs comprises aldonic acid, uronic acid, aldaric acid or a combination thereof.

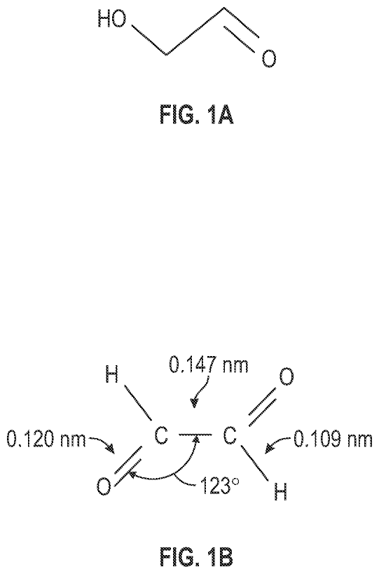

In one or more aspects, the one or more SOPs comprise glycolaldehyde, glyoxal or a blend thereof. Alternatively, the one or more SOPs comprises a blend of glycolaldehyde and glyoxal, hereinafter termed a DIGLY. The structures of glycolaldehyde and glyoxal are depicted in FIGS. 1A and 1B, respectively. A DIGLY suitable for use in the present disclosure may comprise a blend of glycolaldehyde and glyoxal having a ratio of glycolaldehyde to glyoxal of about 100:1, alternatively about 75:1, alternatively about 25:1, alternatively about 10:1, alternatively about 1:10, alternatively about 5:1, alternatively about 1:5, alternatively about 3:1, alternatively about 1:1 or alternatively about 1:100. In some aspects, the DIGLY suitable for use in the present disclosure comprises a blend of glycolaldehyde and glyoxal having a ratio of glycolaldehyde to glyoxal between any of the ranges provided in the preceding sentence.

In one or more aspects, the one or more SOPs has a countercation. Suitable countercations include an alkali metal (Group I) or an alkaline earth metal (Group II) counter-cation. In some embodiments, the cation counterpart is sodium, potassium, calcium or ammonium. In one or more aspects, a salt-free (i.e., fully acidified) one or more SOPs is used in the MUM. The one or more SOPs may be present in the MUM in an amount ranging from about 0.01 weight percent (wt. %) to about 80 wt. %, alternatively from about 0.01 wt. % to about 10 wt. %, alternatively from about 20 wt. % to about 80 wt. % or alternatively from about 1 wt. % to about 30 wt. % based on the total weight of the MUM.

Alternatively, the one or more SOPs (e.g., blend of glycolaldehyde and glyoxal) is present in a MUM that functions as an antifoulant. In such aspects, the one or more SOPs may be present in the MUM in an amount that provides some user and/or process desired ratio of the one or more SOPs to foulant (e.g., cation foulant). For example, the MUM may be used to control the level of a cation foulant in a system where the one or more SOPs is present in the MUM in an amount that provides a stoichiometric ratio of 0.1 to 10 (0.1 parts of one or more SOPs to 10 parts of cation foulant), alternatively a stochiometric ratio of 0.5 to 6, or alternatively a stochiometric ratio of 0.1 to 2.

In another example, the MUM functions to mitigate levels of undesirable materials in a hydrocarbon fluid. In such aspects, the one or more SOPs may be included in the MUM in an amount that provides a final concentration of one or more SOPs ranging from about 0.01 weight percent (wt. %) to about 30 wt. %, alternatively about 0.01 wt. % to about 10 wt. %, alternatively from about 1 wt. % to about 30 wt. %, or alternatively from about 0.5 wt. % to about 5 wt. % based on the total weight of the hydrocarbon fluid.

In one or more aspects, the MUM comprises a solvent. A solvent suitable for use in the present disclosure may comprise an aqueous fluid, a glycol, an alcohol or a combination thereof. Non-limiting examples of alcohols suitable for use in the MUM include methanol, ethanol, propanol, isopropanol, n-butanol, isobutanol, pentanol, hexanol, heptanol, octanol, benzyl alcohol, cyclohexanol, ethylene glycol, 1,2-butanediol, isoamyl alcohol, 1,2-propanediol, 1,3-propanediol, phenol, glycerol, and combinations thereof. Nonlimiting examples of glycols suitable for use in the MUM include ethylene glycol, propylene glycol, monoethers or diethers of glycols (e.g., dimethyl glycol ether) and combinations thereof. Aqueous fluids that may be suitable for use in the MUM include water from any source. Such aqueous fluids may include fresh water, salt water (e.g., water containing one or more salts dissolved therein), brine (e.g., saturated salt water), seawater, or combinations thereof. The aqueous fluids may be from a source that does not contain compounds that adversely affect other components of the MUM or the system to which the MUM is introduced.

In another aspect, the solvent comprises water and the DIGLY is combined with water to form an aqueous solution having an activity ranging from about 1% active to about 50% active or, alternatively about 40% active.

In one or more aspects, the MUM comprises at least one surfactant. The at least one surfactant can be selected from the group consisting of alcohol ethoxylates, fatty alcohol ethoxylates, alkylphenol ethoxylates, nonoxynols, fatty acid esters of sorbitol, alkyl ether carboxylic acids, ethoxysulfates, and combinations thereof.

Alcohol ethoxylates are a class of surfactants that contain a hydrophobic alkyl chain attached via an ether linkage to a hydrophilic ethylene oxide (EO) chain. Fatty alcohol ethoxylates can be generated by ethoxylating fatty alcohols, wherein the fatty alcohols can include from about 3 carbons to about 30 carbons and can be derived from natural fats and oils. Alkylphenol ethoxylates are surfactants consisting of branched-chain alkylphenols (e.g., octylphenol and nonylphenol), which have been reacted with ethylene oxide to produce an ethoxylate chain. Nonoxynols are a family of surfactants which can be produced by ethoxylation of alkylphenols. Nonoxynols vary in the number of repeating ethoxy (oxy-1,2-ethanediyl) groups resulting in nonoxynol-4, nonoxynol-7, nonoxynol-9, nonoxynol-14, nonoxynol-15, nonoxynol-18, and the like. Sorbitan fatty acid esters are mono-, di-, and tri-esters of fatty acids (such as lauric, stearic, palmitic, and oleic) and sorbitan. Sorbitan is a generic name for anhydrides derived from sorbitol, a crystalline hexahydric alcohol that occurs naturally in fruits, seaweed, and algae. Alkyl ether carboxylic acids exhibit an advantageous combination of aqueous solubility, thermoresponsive behavior and a pH-responsive carboxylic headgroup. Ethoxysulfates, are ionic surfactants that exhibit good water solubility.

In one or more other aspects, the surfactant comprises quaternary ammonium compounds such as didecyl dimethyl ammonium chloride (DDAC)-containing compounds, alkyl dimethyl benzyl ammonium chloride (ADBAC)-containing compounds, ammonium decyl ether sulfate, lauramine oxide, sodium alpha olefin sulfonates, laurel hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, and combinations thereof. In one or more aspects, a surfactant is present in the MUM in an amount ranging from about 0.1 weight percent (wt. %) to about 90 wt. % or alternatively from about 0.5 wt. % to about 80 wt. % based on the total weight of the MUM.

In one or more aspects, a MUM further comprises a chelating agent. Herein a chelating agent refers to a compound able to form two or more separate coordinate bonds with a single central metal atom. Any suitable chelating agent may be present in the MUM in amounts effective to improve one or more performance characteristics of the MUM. Nonlimiting examples of chelating agents suitable for use in the present disclosure include gluconic acid, glucaric acid, galactonic acid, galactaric acid, glucoheptonic acid, trisodium phosphate, phosphonates, ethylenediaminetetraacetic acid (EDTA), nitrilotriacetic acid (NTA), methylglycinediacetic acid (MGDA), glutamic acid, N,N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), salts thereof or combinations thereof.

In an aspect, the chelating agent is present in the MUM in an amount ranging from about 0.1 wt. % to about 99 wt. %, alternatively from about 1 wt. % to about 90 wt. % or alternatively from about 2 wt. % to about 50 wt. % based on the total weight of the MUM.

In one or more aspects, a MUM may be used in conjunction with a biocide. Nonlimiting examples of biocides that may be used in conjunction with the MUM include benzoic acids, sorbic acids, sodium sulfite, propionates, glutaraldehyde, quaternary ammonium compounds, brominated organic compounds, phosphonium salts, tetrakis hydroxymethyl-phosphonium sulfates and chlorides, citric acid, bronopol, 2,2-dibromo-3-nitrilopropionamide (DBNPA), glutaraldehyde, 2,2-dibromo-3-nithlopropionamide (DBNPA), 2-bromo-2-nitropropane-1,3-diol (BRONOPOL), 5-chloro-2-methyl-4-isothiazolin-3-one (CMIT), 2-methyl-4-isothiazolin-3-one (MIT), a mixture of CMIT and MIT, 1,2-dibromo-2,4-dicyanobutane, bis(trichloro-methyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthalaldehyde, quaternary ammonium compounds (“quats”) such as n-alkyl dimethyl benzyl ammonium chloride, didecyl dimethyl ammonium chloride (DDAC) or alkenyl dimethylethyl ammonium chloride, guanidines, biguanidines, pyrithiones, carbamates, 3-iodopropynyl-N-butylcarbamate, phosphonium salts such as tetrakis hydroxymethyl phosphonium sulfate (THPS), 3,5-dimethyl-1,3,5-thiadiazinane-2-thione (Dazomet), 2-(thiocyanomethylthio) benzothiazole, methylene bisthiocyanate (MBT), chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, such as peracetic acid, performic acid, percarbonate or persulfate salts, halogenated hydantoins, e.g., monohalodimethylhydantoins such as monochlorodimethylhydantoin, or dihalodi-methylhydantoins such as chlorobromodimethylhydantoin, monochloramines, monobromamines, dihaloamines, trihaloamines, active halogen compounds reacted with other nitrogenous compounds such as urea, salts thereof or combinations thereof. The amount of biocide for use in conjunction with the MUM will vary depending on the application and may be determined by one of ordinary skill in the art with the benefits of the present disclosure.

In one or more aspects, the MUM functions as an antimicrobial agent. In some aspects, the antimicrobial agent is a component of a formulation that functions as a bactericide, a fungicide, a sporicide, an algaecide, an antiviral, or any combination thereof. In some aspects, the MUM provides one or more of (i) short-term elimination of microbial activity, (ii) long-term provision of an essentially microbe-free environment, or (iii) resistance to postproduction contamination, or combinations thereof.

In one or more aspects, the MUM is a component of one or more compositions or products, such as a personal care product, home care product, cosmetic, paint, glue, coating, solvent, spray, dispersion, emulsion, suspension, soap, detergent, household or industrial cleaning agent, paste, gel, lubricant, cooling fluid, heat exchange fluid, contact cooling system, aqueous system, glue, precoat, topcoat, peelable coat, primer, metal primer, paint, stoving paint, coating for printed circuit boards, coating for singular application as well as compound manufacture of film, foil, woven or nonwoven textile, carpet backing, flooring solution, binder for fibers, artificial grass, concrete sealer, dust binder, sound dampening compound coating for use in architectural or in situ mechanical systems, feed product, food product, pesticide, medicament, cosmetic product or pharmaceutical product.

Other nonlimiting applications of the MUM include inhibiting the growth of bacteria and fungi in aqueous paints, adhesives, latex emulsions, and joint cements; preserving wood; preserving cutting fluids, controlling slime-producing bacteria and fungi in pulp and papermills and cooling towers; as a spray or dip treatment for textiles and leather to prevent mold growth; protecting paint films, such as exterior paints from attack by fungi which occurs during weathering of the paint film; protecting processing equipment from slime deposits during manufacture of cane and beet sugar; preventing microorganism buildup and deposits in air washer or scrubber systems and in industrial fresh water supply systems; controlling microorganisms contamination and deposits in oil field drilling fluids and muds, and in secondary petroleum recovery processes; preventing bacterial fungal growth in paper coating processes; controlling bacterial and fungal growth and deposits during the manufacture of various specialty boards, e.g., cardboard and particle board; preventing sap stain discoloration on freshly cut wood of various kinds; controlling bacterial fungal growth in clay and pigment slurries of various types; as a hard surface disinfectant to prevent growth of bacteria and fungi on walls, floors, etc.; in swimming pools to prevent algae growth; inhibiting the growth of harmful bacteria, yeasts, fungi on plants, trees, fruits, seeds, or soil; protecting animal dip compositions against the buildup of microorganisms, and in photoprocessing to prevent buildup of microorganisms, as a human hygiene biocidal product, veterinary hygiene biocidal products, food and feed area disinfectants, drinking water disinfectants, in-can preservative, film preservative, wood preservative, fiber, leather, rubber and polymerized materials preservative, masonry preservative, preservatives for liquid-cooling and processing systems, slimicide, metalworking-fluid preservatives, rodenticide, avicides, molluscicides, piscicides, insecticides, acaricides and products to control other arthropods, repellents, attractants, antifouling product, embalming and taxidermist fluids and combinations thereof.

In one or more aspects, the MUM is used in any suitable form such as in a dispersion, emulsion, suspension, gel, paste, or liquid. In some aspects, the MUM can be added to a feed and/or food product. In one or more aspects, the MUM can be added to a pharmaceutical or cosmetic product. In one or more aspects, the MUM can be added to a biological sample.

Application of the MUM to a system in need thereof may be through any conventional methodology for the introduction of a MUM to that system. For example, a MUM may be introduced in an application (e.g., oilfield operations) via batch mode, continuous mode or “on-the-fly.” A MUM may be applied to a growing medium, applied to a plant, introduced to one or more water inputs to a system or combinations thereof.

In another exemplary aspect, the MUM may be applied to lawns, flower or vegetable beds, arable land, meadowland, orchards or woodland, or hydroponic beds, or to the seeds, roots, leaves, flowers, fruit and/or stems of plants. In yet another aspect, the MUM may be applied to paths, roads, walls, wood-work, brickwork or similar invasible surfaces.

In other aspects, the MUM may function in controlling moss or sessile algae in lawns or on paths or walls, as seed dressings, as sprays for controlling fungal, bacterial or viral infections on leaves, flowers and fruit, such as mildew, botrytis, rust, fusarium, mosaic diseases or wilt, for application to soil or to the roots of seedlings (e.g. of brassica seedlings to inhibit club root) and in the control of numerous fungal, viral, protozoal and bacterial diseases of plants

In one or more aspects, the MUM functions as a hydrogen sulfide (H₂S) scavenger. Consequently, in one or more aspects, a MUM can be combined with other H₂S scavengers such as glutaraldehyde, triazine, and hydantoin in amounts effective to provide improved H₂S scavenger functionality.

In one or more aspects, a MUM comprises a DIGLY and a solvent such as water. In one or more aspects, a MUM comprises a DIGLY and a chelating agent. In one or more aspects, a MUM comprises a DIGLY, a chelating agent and a solvent. In one or more aspects, a MUM comprises a DIGLY, a surfactant, a chelating agent and a solvent. In one or more aspects, a MUM comprises a DIGLY, and a sulfide scavenger. In one or more aspects, a MUM comprises a DIGLY, a solvent and a sulfide scavenger. In one or more aspects, a MUM comprises a DIGLY, a solvent, a chelating agent and a sulfide scavenger. In one or more aspects, a MUM comprises a solvent and at least one compound selected from the group consisting of glutaraldehyde, quaternary ammonium cation, brominated organic compounds, phosphonium salts, hydrogen peroxide, peracetic acid, bleach, isothiazolinone, isothiazolothione, derivatives thereof and combinations thereof.

Disclosed herein are MUMs comprising a DIGLY that function as biocides with applicability to disinfectant and sanitizing formulations and finds utility in cleaning applications. Other relevant applications for these novel DIGLY containing formulations can include but are not limited to, insect repellent, antimicrobial, attractant, sterilizer, disinfectant, sanitizer, fungicide, nematocide, fumigant, herbicide, defoliant, desiccant, antifoulant, insecticide, rodenticide, algaecide, preservative, molluscicide and water purifiers.

In an alternative aspect, a DIGLY has additional utility as a crosslinker for polymers such as polyvinyl alcohol (PVA), polyacrylamide, and cellulose. In such aspects, the DIGLY may function in direct applications related to crosslinking paper products such as cardboard and paper.

### ADDITIONAL DISCLOSURE

A first aspect which is a mitigating composition comprising (i) one or more sugar oxidation products; (ii) a solvent; and (iii) one or more compounds selected from the group consisting essentially of a surfactant, a chelating agent, a biocide, and combinations thereof.

A second aspect which is the composition of the first aspect wherein the one or more sugar oxidation products comprise a blend of glycolaldehyde and glyoxal.

A third aspect which is the composition of any of the first through second aspects wherein the glycoaldehyde:glyoxal ratio is about 100:1.

A fourth aspect which is the composition of the second aspect wherein the glycoaldehyde:glyoxal ratio is about 3:1.

A fifth aspect which is the composition of the second aspect wherein the glycoaldehyde:glyoxal ratio is about 2:1.

A sixth aspect which is the composition of the second aspect wherein the glycoaldehyde:glyoxal ratio is about 1:1.

A seventh aspect which is the composition of any of the first through sixth aspects wherein the solvent comprises an aqueous fluid, an alcohol, a glycol or combinations thereof.

An eighth aspect which is the composition of any of the first through seventh aspects wherein the alcohol comprises methanol, ethanol, propanol, isopropanol, n-butanol, isobutanol, pentanol, hexanol, heptanol, octanol, benzyl alcohol, cyclohexanol, ethylene glycol, 1,2-butanediol, isoamyl alcohol, 1,2-propanediol, 1,3-propanediol, benzyl alcohol, phenol, cyclohexanol, glycerol, or combinations thereof.

A ninth aspect which is the composition of any of the first through eighth aspects wherein the glycol comprises ethylene glycol, propylene glycol, monoethers of glycols, diethers of glycols or combinations thereof.

A tenth aspect which is the composition of any of the first through ninth aspects wherein the aqueous fluid comprises fresh water, salt water, brine, seawater, or combinations thereof.

An eleventh aspect which is the composition of any of the first through tenth aspects wherein the surfactant is selected from the group consisting of alcohol ethoxylates, fatty alcohol ethoxylates, alkylphenol ethoxylates, nonoxynols, fatty acid esters of sorbitol, alkyl ether carboxylic acids, ethoxysulfates, quaternary ammonium compounds, alkyl dimethyl benzyl ammonium chloride (ADBAC)-containing compounds, ammonium decyl ether sulfate, lauramine oxide, sodium alpha olefin sulfonates, laurel hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, and combinations thereof.

A twelfth aspect which is the composition of any of the first through eleventh aspects wherein the biocide comprises benzoic acids, ascorbic acids, sodium sulfite, propionates, glutaraldehyde, quaternary ammonium compounds, brominated organic compounds, phosphonium salts, tetrakis hydroxymethyl-phosphonium compounds, citric acid, 2,2-dibromo-3-nitrilopropionamide (DBNPA), glutaraldehyde, 2,2-dibromo-3-nitrilopropionamide (DBNPA), 2-bromo-2-nitropropane-1,3-diol (Bronopol), 5-chloro-2-methyl-4-isothiazolin-3-one (CMIT), 2-methyl-4-isothiazolin-3-one (MIT), a mixture of CMIT and MIT, 1,2-dibromo-2,4-dicyanobutane, bis(trichloro-methyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthalaldehyde, quaternary ammonium compounds (“quats”) guanidines, biguanidines, pyrithiones, carbamates, 3-iodopropynyl-N-butylcarbamate, phosphonium salts, tetrakis hydroxymethyl phosphonium sulfate (THPS), 3,5-dimethyl-1,3,5-thiadiazinane-2-thione, 2-(thiocyanomethylthio) benzothiazole, methylene bisthiocyanate (MBT), chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, persulfate salts, halogenated hydantoins, dihalodimethylhydantoins, monochloramines, monobromamines, dihaloamines, trihaloamines, active halogen compounds, salts thereof and combinations thereof.

A thirteenth aspect which is a method comprising introducing to a system a mitigating composition in an amount effective to control the amount of a pathogenic organism associated with the system wherein the mitigating composition comprises (i) one or more sugar oxidation products; (ii) a solvent; and (iii) one or more compounds selected from the group consisting essentially of a surfactant, a chelating agent, a biocide, and combinations thereof.

A fourteenth aspect which is the method of the thirteenth aspect wherein the one or more sugar oxidation products comprise glycolaldehyde and glyoxal.

A fifteenth aspect which is the method of any of the thirteenth through fourteenth aspects wherein the solvent comprises an aqueous fluid, an alcohol, a glycol or combinations thereof.

A sixteenth aspect which is the method of any of the thirteenth through fifteenth aspects wherein introduction of the mitigating composition to the system comprises application of the mitigating composition to a growing medium, application of the mitigating composition to a plant, introduction of the mitigating composition to one or more water inputs of the system or combinations thereof.

A seventeenth aspect which is a blend comprising (i) a mitigating composition and (ii) a material selected from the group consisting of a feed product, a food product, a pesticide, a medicament, a pharmaceutical product, a cosmetic product and a combination thereof.

An eighteenth aspect which is the blend of the seventeenth aspect wherein the mitigating composition comprises glycolaldehyde and glyoxal.

A nineteenth aspect which is the blend of any of the seventeenth through eighteenth aspects wherein the mitigating composition further comprises a solvent.

A twentieth aspect which is the blend of the nineteenth aspect wherein the solvent comprises an aqueous fluid, an alcohol, a glycol or combinations thereof.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

A minimum inhibitory concentration (MIC) of a MUM was determined and compared to that of the biocide glutaraldehyde. Specifically, the indicated compound or blend of compounds was used to treat a wildtype E. coli strain and the effect of this treatment on bacterial count used to determine the MIC. The results are presented in Table 1.

TABLE 1

| | | general wild |
|---|---|---|
| | E. Coli | strain bacteria |
| Biocides | MIC [ppm] | |
| 40% glutaraldehyde | 1000 | 1000 |
| 39% glyoxal | 1000 | >1000 |
| 39% 1,4 dioxane 2,5 diol | 1000 | >1000 |
| 40% glyoxal - 1,4 dioxane 2,5 diol blend lot 2 | 1000 | 1000 |
| 40% glyoxal - 1,4 dioxane 2,5 diol blend lot 3 | 1000 | 1000 |
| 40% glyoxal - 1,4 dioxane 2,5 diol blend lot 4 | 1000 | 1000 |

In a MIC study it was found that a mixture of glycolaldehyde and glyoxal was competitive with conventional biocides such as glutaraldehyde. As seen in Table 1, the MIC for the mixtures were the same as conventional glutaraldehyde. The single component products failed to provide MIC for general wild strain bacteria. However, the mixture of the glyoxal and glycolaldehyde (1,4 dioxane 2,5 diol) provided competitive performance to glutaraldehyde. The composition of the different glycolaldehyde-glyoxal blends are given in Tables 2-4.

TABLE 2

| | RAW Material-Lot 2 | % By Weight |
|---|---|---|
| 1 | 39% Glyoxal | 50.0 |
| 2 | 39% 1,4 dioxane 2,5 diol | 50.0 |
| | TOTAL | 100.00 |

TABLE 3

| | RAW Material-Lot 3 | % By Weight |
|---|---|---|
| 1 | 39% Glyoxal | 34.0 |
| 2 | 39% 1,4 dioxane 2,5 diol | 66.0 |
| | TOTAL | 100.00 |

TABLE 4

| | RAW Material-Lot 4 | % By Weight |
|---|---|---|
| 1 | 39% Glyoxal | 66.0 |
| 2 | 39% 1,4 dioxane 2,5 diol | 34.0 |
| | TOTAL | 100.00 |

The subject matter having been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A mitigating composition, comprising:
(i) one or more sugar oxidation products;
(ii) a solvent; and
(iii) one or more compounds selected from the group consisting essentially of a surfactant, a chelating agent, a biocide, and combinations thereof.

2. The composition of claim 1, wherein the one or more sugar oxidation products comprise a blend of glycolaldehyde and glyoxal.

3. The composition of claim 2, wherein the glycoaldehyde:glyoxal ratio is about 100:1.

4. The composition of claim 2, wherein the glycoaldehyde:glyoxal ratio is about 3:1.

5. The composition of claim 2, wherein the glycoaldehyde:glyoxal ratio is about 2:1.

6. The composition of claim 2, wherein the glycoaldehyde:glyoxal ratio is about 1:1.

7. The composition of claim 1, wherein the solvent comprises an aqueous fluid, an alcohol, a glycol or combinations thereof.

8. The composition of claim 1, wherein the alcohol comprises methanol, ethanol, propanol, isopropanol, n-butanol, isobutanol, pentanol, hexanol, heptanol, octanol, benzyl alcohol, cyclohexanol, ethylene glycol, 1,2-butanediol, isoamyl alcohol, 1,2-propanediol, 1,3-propanediol, benzyl alcohol, phenol, cyclohexanol, glycerol, or combinations thereof.

9. The composition of claim 1, wherein the glycol comprises ethylene glycol, propylene glycol, monoethers or diethers of glycols or combinations thereof.

10. The composition of claim 1, wherein the aqueous fluid comprises fresh water, salt water, brine, seawater, or any combination thereof.

11. The composition of claim 1, wherein the surfactant is selected from the group consisting essentially of alcohol ethoxylates, fatty alcohol ethoxylates, alkylphenol ethoxylates, nonoxynols, fatty acid esters of sorbitol, alkyl ether carboxylic acids, ethoxysulfates, quaternary ammonium compounds, alkyl dimethyl benzyl ammonium chloride (ADBAC)-containing compounds, ammonium decyl ether sulfate, lauramine oxide, sodium alpha olefin sulfonates, laurel hydroxysultaines, betaines, dimethylamine oxides, diphenyl oxide sulfonates, alkanolamides, laureth sulfates, benzene sulfonic acids, alkyl benzene sulfonates, alpha olefin sulfonates, tall oil fatty acid quats, coco-quats, and combinations thereof.

12. The composition claim 1, wherein the biocide is selected from the group consisting essentially of benzoic acids, ascorbic acids, sodium sulfite, propionates, glutaraldehyde, quaternary ammonium compounds, brominated organic compounds, phosphonium salts, tetrakis hydroxymethyl-phosphonium compounds, citric acid, 2,2-dibromo-3-nitrilopropionamide (DBNPA), glutaraldehyde, 2,2-dibromo-3-nitrilopropionamide (DBNPA), 2-bromo-2-nitropropane-1,3-diol (BRONOPOL), 5-chloro-2-methyl-4-isothiazolin-3-one (CMIT), 2-methyl-4-isothiazolin-3-one (MIT), a mixture of CMIT and MIT, 1,2-dibromo-2,4-dicyanobutane, bis(trichloro-methyl)sulfone, 2-bromo-2-nitrostyrene, 4,5-dichloro-1,2-dithiol-3-one, 2-n-octyl-4-isothiazolin-3-one, 1,2-benzisothiazolin-3-one, ortho-phthalaldehyde, quaternary ammonium compounds (“quats”) guanidines, biguanidines, pyrithiones, carbamates, 3-iodopropynyl-N-butylcarbamate, phosphonium salts, tetrakis hydroxymethyl phosphonium sulfate (THPS), 3,5-dimethyl-1,3,5-thiadiazinane-2-thione, 2-(thiocyanomethylthio) benzothiazole, methylene bisthiocyanate (MBT), chlorine, alkali and alkaline earth hypochlorite salts, hypochlorous acid, chlorinated isocyanurates, bromine, alkali and alkaline earth hypobromite salts, hypobromous acid, bromine chloride, chlorine dioxide, ozone, hydrogen peroxide, peroxy compounds, persulfate salts, halogenated hydantoins, dihalodimethylhydantoins, monochloramines, monobromamines, dihaloamines, trihaloamines, active halogen compounds, salts thereof and combinations thereof.

13. A method comprising:
introducing to a system a mitigating composition in an amount effective to control the level of a pathogenic organism associated with the system, wherein the mitigating composition comprises (i) one or more sugar oxidation products; (ii) a solvent; and (iii) one or more compounds selected from the group consisting essentially of a surfactant, a chelating agent, a biocide, and combinations thereof.

14. The method of claim 13, wherein the one or more sugar oxidation products comprise a blend of glycolaldehyde and glyoxal.

15. The method of claim 13, wherein the solvent comprises an aqueous fluid, an alcohol, a glycol or a combination thereof.

16. The method of claim 13, wherein introduction of the mitigating composition to a system comprises application of the composition to a growing medium, application of the composition to a plant, introduction of the composition to one or more water inputs of a system or combinations thereof.

17. A blend, comprising:
(i) a mitigating composition and
(ii) a material selected from the group consisting of a feed product, a food product, a pesticide, a medicament, a pharmaceutical product, a cosmetic product and combinations thereof.

18. The blend of claim 17, wherein the mitigating composition comprises glycolaldehyde and glyoxal.

19. The blend of claim 17, wherein the mitigating composition further comprises a solvent.

20. The blend of claim 19, wherein the solvent comprises an aqueous fluid, an alcohol, a glycol or a combination thereof.
